(19) United States
(12) Patent Application Publication
(10) Pub. No.: US 2004/0026827 A1
(43) Pub. Date: Feb. 12, 2004

(54) Method for the fabrication of crystallizable resins and articles therefrom

(76) Inventors: Issam Dairanieh, Naperville, IL (US); Stefanos L. Sakellarides, Naperville, IL (US)

Correspondence Address: BP America Inc., Docket Clerk, BP Legal, M.C. 5East, 4101 Winfield Road, Warrenville, IL, 60555, US

(21) Appl. No.: 10/460,555

(22) Filed: Jun. 12, 2003

Related U.S. Application Data
(60) Provisional application No. 60/392,328, filed on Jun. 28, 2002.
(60) Provisional application No. 60/431,545, filed on Dec. 6, 2002.

(51) Int. Cl. D02J 1/22; B29C 49/08

(52) U.S. Cl. 264/288.4; 264/290.2

(57) ABSTRACT

Precrystallizing an amorphous crystallizable thermoplastic article, such as an amorphous polyethylene terephthalate article, by heating to thermally induce crystallinity, then orienting at a temperature that is preferably greater than the crystallizing temperature, provides articles having substantially improved thermal dimensional stability together with high tensile modulus properties. The process is particularly useful in the production of containers suitable for use in hot-fill applications.

### RELATED APPLICATIONS

This application claims the benefit under 35 U.S.C. § 119(e) of U.S. Provisional Application No. 60/392,328 (“the '328 application”) filed on Jun. 28, 2002 and of U.S. Provisional Application No. 60/431,545 (“the '545 application”) filed on Dec. 6, 2002. The '328 application and the '545 application are incorporated by reference in this specification.

This invention relates generally to the fabrication of crystallizable resins and more particularly to an improved method for fabrication of crystallizable polyesters including polyethylene terephthalate (PET) resins.

Articles fabricated from PET resins according to the invented method are highly crystalline, with high modulus and strength properties. Articles of this invention, and particularly blow-molded articles, exhibit unexpectedly low shrinkage compared with articles fabricated according to the art. The invention thus may also be described as directed to polyester articles having improved dimensional stability.

### BACKGROUND OF THE INVENTION

The mechanical properties of a crystallizable thermoplastic such as, for example, polyethylene terephthalate (PET), are substantially affected by the level of crystallinity. Amorphous PET generally has low strength properties and poor barrier properties. As the material is oriented and/or crystallized, strength and modulus properties are increased. At high levels of crystallinity, the softening temperature of the resin is increased, improving the dimensional stability at elevated temperatures.

Methods disclosed in the art for inducing and controlling the level of crystallinity in thermoplastics include strain-induced crystallization (SIC), generated by orienting the resin in a stretching operation, and thermally-induced crystallization (TIC), created by heating the resin at a temperature above the resin glass transition temperature (Tg).

Different morphologies result from the two processes. Stretching establishes axial molecular alignment and initiates strain-induced crystallization in those materials that are susceptible to the generation of such a morphology. Stretching and orienting a substantially amorphous resin, whether done uniaxially or, preferably, biaxially, i.e. along two orthogonal axes, provides nucleation sites from which typical spherulitic crystal regions propagate in an ordered lamellar array. Since many such sites are created, the resulting crystallites are small and finely dispersed and the oriented resin generally remains transparent, with minimal haze.

Thermally-induced crystallization of an amorphous resin provides large, randomly dispersed spherulites that tend to embrittle the resin. Moreover, the larger spherulites create haze, causing the article to whiten and become opaque.

Preferably, the two crystallizing processes are used to supplement each other. Highly oriented resins have substantially improved strength properties, and the gas barrier properties of the material are significantly improved by orienting. However, oriented resin articles are generally thermally dimensionally unstable; when heated above the Tg of the resin, such articles shrink and become distorted. For example, when heated at temperatures significantly greater than the resin Tg, oriented polyester containers can become wavy in appearance and exhibit volumetric shrinkage as great as from about 12 to 50% unless further stabilized in some manner. Dimensional instability in such articles may be overcome by heat treating to thermally induce crystallization. Although thermally inducing crystallinity in an amorphous resin causes the resin to whiten and become opaque, superimposing thermally-induced crystallinity on stretch-oriented PET resin improves dimensional stability without causing a reduction in transparency.

Heat setting processes suitable for this purpose are well known and have been widely used in the packaging arts. For example, in the method disclosed in U.S. Pat. No. 4,233,022, a container is created by stretch blowing an amorphous preform with less than about 5% crystallinity into a mold heated to the crystallizing temperature of the resin. The container walls, biaxially oriented in the stretch blowing process, contact the heated mold and become thermally crystallized, thereby enhancing the dimensional stability of the container while maintaining the mechanical properties produced by orienting.

According to patentees, the stretch blowing will be carried out within a narrow temperature range. For a typical amorphous PET polymer with a glass transition temperature of about 76° C., the parison will generally be heated to a temperature in the range of from about 75 to about 110° C. According to the further teachings of the cited art, the orientation process is adversely affected by spherulite growth, which occurs more readily at higher temperatures; temperatures significantly greater than this narrow range are therefore to be avoided.

Application of heat via the mold is inefficient, and thus extended contact times are needed to complete the heat setting step. While the described process provides materials with superior dimensional stability, it is more costly because of the extended cycle time. Moreover, because the stretch or draw of the resin is not uniform, there are areas of low orientation, for example, in the heel and shoulder portions of the container. Highly oriented areas remain transparent when heat set, but areas having a low level of orientation tend to whiten and become opaque as the thermal crystallization proceeds. Careful control of the heat setting step, possibly including additional operations to cool specific areas where the resin is more amorphous, is often needed to avoid such whitening and produce satisfactory containers.

Operating the two-stage, high output, reheat blow molding machines that are widely employed commercially for producing PET resin articles at reduced throughput in order to extend cycle times and properly heat set articles would cause substantial reduction in productivity. Moreover, bottles and other articles that will be heat set generally have heavier walls in order to withstand the heat setting operation, requiring as much as 50% more resin in their manufacture. These and other factors can cause a commercially unacceptable increase in production cost.

Jabarin, in Poly. Sci. and Eng. 31 1071 (1991), discloses thermally crystallizing PET film at 120° C. to induce up to 20% crystallinity, then uniaxially orienting the crystallized film at temperatures at least 20° C. below the crystallizing temperature, i.e. from 80° C. up to 100° C. According to Jabarin, orienting films with high levels of thermally induced crystallinity produces film having poor shrinkage characteristics.

A method for producing dimensionally stable articles from PET resins or other crystallizable resins without resort to lengthy mold cycles would thus be an important advance in the resin molding arts.

### SUMMARY OF THE INVENTION

The invention is directed to a method for the fabrication of crystallizable polyester resins comprising the step of orienting a thermally crystallized polyester article at an elevated temperature.

More particularly described, in the invented process an opaque, thermally crystallized polyester article or preform is oriented at an elevated temperature to provide a substantially transparent, oriented crystalline polyester article with improved dimensional stability. In a further embodiment, an article or preform comprising an amorphous, crystallizable polyester resin is heated to thermally induce crystallinity, and then oriented at a temperature at least equal to the crystallization temperature, more preferably at a substantially higher temperature, to provide a substantially transparent, oriented crystalline polyester article.

Articles comprising oriented crystallized polyester resin produced according to the invention are substantially transparent, with excellent dimensional stability at elevated temperatures. Moreover, the oriented articles of this invention have surprisingly improved thermal dimensional stability even though they are not subjected to a further heat treatment after the orientation step as taught in the art.

The invented process is particularly suited for use in the production of containers intended for use in hot fill applications and the like.

### DETAILED DESCRIPTION OF THE INVENTION

Generally described, the method of this invention comprises orienting a crystallized polyester article at an elevated temperature to provide clear, oriented crystallized polyester articles having a total crystallinity greater than about 15%, with excellent dimensional stability at elevated temperatures.

In one embodiment, the method of this invention comprises the steps of heating an article comprising substantially amorphous, crystallizable polyester at a first elevated temperature, thereby thermally inducing crystallization, and then orienting the resulting opaque, crystallized polyester article at a second elevated temperature equal to or greater than said first temperature. The resulting oriented crystallized polyester article will be clear and have a total crystallinity greater than about 15%, preferably greater than about 20% and more preferably from about 20% to about 60%.

As used herein, percent crystallinity (Xc) of a polyester material means the crystallinity calculated from the density of the resin according to ASTM 1505, using the following formula:

Xc=((dₛ−dₐ)/(d_{c}−dₐ))·100

where: dₛ=density of test sample in g/cm³; dₐ=density of an amorphous film of zero percent crystallinity (for polyethylene terephthalate, 1.333 g/cm³); and d_{c}=density of the crystal calculated from unit cell parameters (for polyethylene terephthalate, 1.455 g/cm³).

Crystallizable polyester resins suitable for use in the practice of the invention are preferably polyethylene terephthalate homopolymer and copolymer resins comprising polyethylene terephthalate wherein a minor proportion of the ethylene terephthalate units are replaced by compatible monomer units. For example, the ethylene glycol moiety may be replaced by aliphatic or alicyclic glycols such as cyclohexane dimethanol (CHDM), trimethylene glycol, polytetramethylene glycol, hexamethylene glycol, dodecamethylene glycol, diethylene glycol, polyethylene glycol, polypropylene glycol, propane-1,3-diol, butane-1,4-diol, and neopentyl glycol, or by a bisphenol and other aromatic diol such as hydroquinone and 2,2-bis(4′-β-hydroxyethoxyphenyl) propane. Examples of dicarboxylic acid moieties which may be substituted into the monomer unit include aromatic dicarboxylic acids such as isophthalic acid (IPA), phthalic acid, naphthalene dicarboxylic acid, diphenyl dicarboxylic acid, diphenoxyethane dicarboxylic acids, bibenzoic acid, and the like, as well as aliphatic or alicyclic dicarboxylic acids such as adipic acid, sebacic acid, azelaic acid, decane dicarboxylic acid, cyclohexane dicarboxylic acid and the like. Copolymers comprising various multifunctional compounds such as trimethylolpropane, pentaerythritol, trimellitic acid and trimesic acid copolymerized with the polyethylene terephthalate may also be found suitable. The use of PET resins comprising up to about 10 wt % ethylene isophthalate units or ethylene naphthalate units in the manufacture of packaging materials and containers has been disclosed in the art. It will be understood that selection of particular comonomer units and the amounts employed will depend in part upon the effect on resin properties, including crystallinity. For most applications, the amount of comonomer will be no more than about 25 mole %, preferably be no more than about 15 mole %, and more preferably no more than about 10 mole %. Although copolymers comprising greater amounts of comonomer, as great as 50 mole %, may be found useful, high levels of comonomer generally tend to interfere with crystallization and thus will not be preferred.

The terms PET and polyethylene terephthalate are used herein interchangeably to mean polyethylene terephthalate homopolymer; the terms PET resin and polyethylene terephthalate resin, as used interchangeably herein, are intended to include both PET homopolymer and PET copolymer.

Crystallizable polyester resins, as well as methods for their preparation, are well known in the art. A wide variety of such resins are readily available from commercial sources in several forms including sheet, film and the like, and as powdered or pelletized resins in a variety of grades such as extrusion grades, molding grades, coating grades and the like, including grades particularly intended for use in making containers. The PET resins may further comprise compatible additives such as, for example, those additives commonly employed in the container and packaging materials arts, including thermal stabilizers, light stabilizers, dyes, pigments, plasticizers, fillers, antioxidants, lubricants, extrusion aids, residual monomer scavengers, and the like.

PET resins having an intrinsic viscosity (I.V.) in the range of from about 0.55 to about 1.04, preferably from about 0.65 to 0.85, will be suitable for use in the practice of this invention. PET resins having an intrinsic viscosity of about 0.8 are widely used in the packaging industry in a variety of container applications. As used herein, the intrinsic viscosity will be determined according to the procedure of ASTM D-2857, at a concentration of 5.0 mg/ml in a solvent comprising o-chlorophenol, respectively, at 30° C.

The substantially amorphous polyester article or preform may take any of a variety of forms such as film, sheet, molded article, bottle parison, or the like. The article may be formed by any conventional melt processing method such as, for example, injection molding, extrusion, compression molding, and the like. In commercial practice, injection molded articles and preforms, extruded film and sheet, and the like are generally cooled rapidly after the forming operation in order to maintain a high rate of production; such articles will thus generally be amorphous. As generally understood in the art, by substantially amorphous is meant a resin or resin article having no more than about 5% crystallinity and generally less than about 2%.

The amorphous article will be heated at a first temperature T₁ to thermally induce crystallization of the polyester. The amount of thermally induced crystallinity (TIC) that will be achieved when heating an amorphous crystallizable resin is primarily a function of the temperature and time. Selection of T₁ will depend in part upon the particular resin employed; generally, T₁ will be greater than the resin Tg, preferably greater than about (Tg+45° C.), and may be as high as the temperature for onset of crystal melting—for PET, about 232° C. Where maintaining the preform geometry is an important consideration, temperatures near the melt temperature will be avoided. Preferred heat treatment temperatures for crystallizing PET resins will lie in the range of from about 125° C. to about 205° C. As the intrinsic viscosity of the polyester increases, the temperature needed to achieve a given percent crystallinity may also increase.

Heat treatment times will be selected to provide the desired level of crystallinity at the treatment temperature, and may vary from a few seconds up to several minutes or more. During the initial stages of heat treatment, the change in crystallinity achieved is time-temperature dependent; however, extended heating times generally do not result in a significant further increase in crystallinity. In addition to the effect of resin I.V. on crystallization rate, physical factors such as part size and geometry, thickness, particularly wall thickness, heating rate, and the like will affect the time required for the article to reach the desired heat treatment temperature. Thus, the heat treatment times will necessarily vary widely, from as short as about 10 seconds to as great as 10 minutes, and methods-for determining the crystallinity produced in the resin and selecting an appropriate heating time will be readily apparent to those skilled in the art.

For the purposes of this invention, the level of thermally induced crystallinity will be greater than 4%, more preferably greater than about 6% crystallinity. Still more preferably the thermally-induced crystallinity of the article will lie in the range of from about 10 to about 40%. Although still higher levels of crystallinity will be possible, the softening temperature of the resin will be significantly raised, and processability will thus be more difficult. Moreover, as will be more fully described, materials containing very high levels of thermally induced crystallinity tend to experience a reduction in crystallinity when subsequently oriented, depending upon the conditions and processes employed for the orienting step. Hence, very high levels of thermally induced crystallinity will generally not be preferred.

Generally, the heating step may be conducted in any convenient manner, for example, by placing the article in an oven, and may be carried out as an independent step or as part of a continuous operation. The desired high degree of thermal crystallization may be achieved within reasonable cycle times for particular resins by including a nucleating agent to enhance the crystallization rate at the selected crystallization temperature.

In extrusion operations, passing extruded film or sheet through an oven may serve to induce the desired level of crystallization. Molded preforms having the desired level of crystallinity may be conveniently produced during the injection molding operation by use of heated perform molds and gradual cooling of the preform before demolding.

In a conventional bottle blowing operation, the molded bottle preform will be loaded in the blow molding machine and heated to the blow molding temperature as an integral part of the molding operation. It will then be blown into a cold mold. The preform temperature and thereby the crystallinity of the preform at the time of blow molding will thus be determined and controlled by the temperature of the oven.

In the process of this invention, the bottle preforms will generally be heated with short cycle times to temperatures in the range of about 122° C. to about 150° C. before blowing, and thus will have a low level of thermally induced crystallization, generally from about 4 to about 20%. Like the conventional bottle blowing operation, blowing is conducted preferably into a cold mold. Though achieving higher levels of crystallinity in a bottle blowing operation may be possible, lengthy cycle times would be needed which would drive up production costs.

Inducing higher levels of crystallinity thermally will be more practical when the article or preform can be thermally crystallized in a separate heating operation conducted, for example, in an oven prior to forming or molding. In sheet and film applications, levels of thermally induced crystallinity of from about 25 to as great as 40% will be preferred, and still higher levels may also be found useful in some applications. It will be understood that for some sheet and film applications levels of thermally induced crystallinity as low as 10% may also be found useful.

The thermally crystallized polyester preform will be oriented in a stretching or drawing operation carried out at a second elevated temperature T₂.

Amorphous polyester films, moldings, and the like will be substantially transparent unless filled. When heated to induce crystallinity, the appearance of the article or preform will be transformed from substantially transparent to milky white and opaque with the growth of thermally induced spherulites. When subsequently oriented at a temperature at least equal to the crystallization temperature, preferably at a substantially higher temperature, the opaque, thermally crystallized polyester preform becomes a substantially transparent, oriented crystalline polyester article with improved dimensional stability. The surprising transformation of the opaque polyester article into a transparent article by orienting at elevated temperatures is not well understood. As is known, thermally inducing crystallinity in an amorphous resin article creates large, randomly dispersed spherulites that scatter visible light, causing the article to be opaque. While not wanting to be bound by a particular theory of operation, it appears that the thermally induced spherulites are disrupted by being oriented and are thereby reduced in size, possibly creating ordered crystalline regions that do not scatter light. Thus, although oriented crystallized polyester articles produced according to the invention may comprise as much as 50% thermally induced crystallinity in the form of oriented spherulites, the articles will be substantially transparent. Moreover, even though not subjected to a further heat treatment after the orientation step, the oriented articles of this invention have surprisingly improved thermal dimensional stability.

Forming a container or other article from the crystallized preform may be accomplished by any conventional molding technique involving distension of the preform. In this regard, vacuum or pressure forming by drawing a sheet-like preform against the walls of a wide mouth die cavity may be used as well as known and stretch blow molding techniques hereafter described. The particular remolding system or combination of systems chosen will usually be influenced by the configuration of the final container which can vary widely and is primarily determined by the nature of the contents to be packaged therein.

Generally, the crystalline polyester will be oriented at or above the temperature used for thermally inducing crystallization. Preferably, the polyester will be oriented at a temperature at least about 45° C. above the amorphous resin Tg, and more preferably in a range of from about 45° C. to about 125° C. above the amorphous resin Tg. Where a preform is crystallized as part of a blow molding operation, the orienting or blow molding temperature T₂ will be substantially that employed for the crystallization step (T₁). Generally, a temperature in the range of from about 122° C. to about 150° C., preferably from about 125° C. to about 142° C., and still more preferably from about 128° C. to about 139° C. will be found to be effective for orienting PET resins in a blow molding operation according to the invented process.

When the thermal crystallization step can be conducted independently of any limitations imposed by the molding machine, a higher temperature T₁ may be employed to reduce cycle time and to achieve higher levels of crystallinity. The orienting step will be conducted at a temperature T₂ at least equal to, and preferably greater than, the temperature employed in the crystallization, i.e. T₂≧T₁. Although orienting temperatures up to the temperature of onset of crystal melting for the resin may be employed, generally the resin will flow significantly at these higher temperatures and become difficult to handle; hence T₂ will preferably be at least 10° C. lower than the crystal melt onset temperature. For PET resins, T₂, will thus lie in the range of from about 125° C. to about 205° C.

PET resin film, sheet and preforms are readily crystallized by heating at temperatures T₁ above 150° C. to high levels of thermally induced crystallinity, greater than about 25% to as high as 50%. The resulting highly crystallized film, sheet or preform will be conveniently fabricated into an oriented crystalline container or other article, for example by being stretch oriented biaxially, at temperatures T₂ in the range of from about 160° C. to 205° C., preferably from about 160° C. to about 195° C.

The invention will thus be seen to be directed to a method for the fabrication of crystallizable thermoplastics, particularly polyester resins, comprising the steps of providing a crystallized polyester article having greater than about 4% thermally induced crystallinity, and orienting the article at an elevated temperature in the range of from about 125° C. to about 205° C. Preferably, the crystallized polyester article or preform will be oriented at a temperature T₂ that is greater than the temperature used to thermally induce crystallinity in the preform.

The invented process may be described in a further embodiment as comprising the steps of providing an article comprising an amorphous, crystallizable polyester, heating the article to a first temperature T₁ greater than the Tg of the amorphous resin to provide an unoriented crystallized polyester article having from about 4% to about 40%, preferably greater than about 10%, thermally induced crystallinity, and then stretch orienting the crystallized polyester article at a second temperature T₂ equal to or greater than said first temperature to provide a substantially transparent polyester article having a total oriented crystallinity of greater than about 15%. Preferably, T₁>(Tg+45° C.), and T₁≦T₂. For articles comprising a PET resin, T₁ will be greater than about 122° C., and will preferably lie in the range of from about 125° C. to about 205° C., more preferably from about 125° C. to about 195° C., and still more preferably from about 125° C. to about 180° C.

Polyester articles produced in the invented process will have excellent dimensional stability, particularly at the elevated temperatures encountered in hot fill applications. The invented articles are also significantly improved in tensile modulus, compared with articles that are produced by orienting substantially amorphous resins and heat setting according to prior art methods. These high modulus articles may be further characterized as having less than about 5% shrinkage at 100° C. (DMA test), and blow molded containers produced by the invented process will have a volume shrinkage of less than about 7% at 90° C.

The invention described herein will be better understood by consideration of the following examples, which are offered by way of illustration and not intended to be limiting.

### EXAMPLES

The PET resins used in the following examples were commercial grades of packaging resins having IV's in the range 0.75-0.85, obtained variously from KoSa and from M&G Polymers USA.

Film tensile properties were obtained according to ASTM D-882, using a 2 inch gage length, at a crosshead speed of 20 inch/min.

Thermal shrinkage was obtained using a Dynamic Mechanical Analyzer (DMA). Die cut specimens, 0.25 inch×2 inch, were mounted in the film tensile fixture of the DMA, heated to 100° C at 3° C./min. and held at that temperature for 10 min. The change in dimension, expressed as percent shrinkage (% SH), was calculated using the following formula:

% SH=100(L_{f})/L₀

where Lₒ is the initial length and L_{f} is the final length.

CO₂ permeability was determined at 35° C. using a Mocon, Inc. PERMATRAN-C® 4/40 carbon dioxide transmission rate test instrument.

The resin densities were determined at room temperature using a density gradient column. Crystallinity was calculated from the density of the resin according to ASTM 1505, using the following formula:

Xc=((dₛ−dₐ)/(d_{c}−dₐ))·100

where: dₛ=density of test sample in g/cm³; dₐ=density of an amorphous film of zero percent crystallinity (for polyethylene terephthalate, 1.333 g/cm³; for polyethylene isophthalate, 1.356 g/cm³); and d_{c}=density of the crystal calculated from unit cell parameters (for polyethylene terephthalate, 1.455 g/cm³). The calculated amorphous densities of PETI resins are weighted by the respective mole fractions; the crystal density for PETI resins is assumed to be the same as for PET.

Glass transition temperatures Tg may be determined using a differential scanning calorimeter (DSC) at a heating rate of 10° C./min.

Film Extrusion: The pelletized resins, dried in a circulating air oven overnight at 120-140° C., were extruded into 13 or 20 mil sheets using a Killion 1 inch extruder, and collected on quenched rolls to provide substantially amorphous film and sheet.

Biaxial Film Stretching: A T. M. Long laboratory stretcher was used to biaxially stretch 2.25″×2.25″ film specimens. The test specimens were heated by soaking in the oven of the laboratory stretcher for 50-100 sec, then stretched at a speed of 4-6 inches/sec, providing a strain rate of 200-300%/sec. Stretching conditions and extensions are provided in the descriptions of individual examples.

Bottle fabrication: Preforms used in the following examples were injection molded using various standard injection molding machines, for example, a Husky Injection Molding Systems Ltd. PET screw injection molding machine, using procedures and methods commonly employed in the molding arts for fabricating PET resins. The cycle times and temperatures were selected to provide substantially amorphous preforms.

Conventional stretch blow molding equipment, as represented by a Sidel SBO series 2 molding machine having an output of 1400 bottles per hour, was used to heat and blow mold bottles from injection molded preforms according to methods commonly employed in the container arts. Temperatures employed in the molding operations are indicated in the descriptions of the particular examples.

Dimensional changes in bottles were determined at different cross sections before and after hot-filling. The % change (% CH) is defined as

% CH=100(D_{f}−D₀)/D₀

where Dₒ is the initial diameter and D_{f} is the final diameter. The change in volume was determined by overfilling the bottle before and after hot-filling and determining the volume of water.

### Example 1

Extruded 13 mil transparent amorphous PET film was thermally crystallized by heating in an oven at 160° for 30 min. The film, now opaque, had a density of 1.3772, corresponding to a crystallinity of 36%. A 2 inch by 2 inch specimen cut from the film was placed in a T. M. Long laboratory film stretcher and, after heat soaking at 204° C. for 2.5 min, was biaxially stretched at 204° C. The stretched sample had a density of 1.387 g/cc (45% crystallinity). The film lost its opacity and became transparent.

### Examples 2-5 and Comparison Example C-2

Additional pieces of 13 mil amorphous PET film were thermally crystallized at 160° C. for varying times to provide opaque crystalline film.

The 2 inch by 2 inch specimens were cut from each of the films and biaxially stretched to a 3×3 extension at 204° C., as described above. The specimens again become transparent on stretching.

### Example C-1

A 2 inch by 2 inch specimen cut from amorphous PET film was biaxially stretched to a 3×3 extension at 102° C. to provide an oriented film for comparison purposes.

The initial and final crystallinities of the specimens, calculated from density measurements as described above, together with tensile modulus of the stretched specimens are summarized in the following Table 1.

TABLE 1

Crystallinity

| Ex. | Time | Initial | Total | Modulus |
|---|---|---|---|---|
| No. | Min. | % | % | Kpsi |
| C-1 | 0 | 3.2 | 27.0 | 437 |
| C-2 | 1 | 3.1 | — | — |
| 2 | 2 | 28.8 | 48.9 | 446 |
| 3 | 3 | 29.9 | 48.5 | 481 |
| 4 | 10 | 34.4 | 48.0 | 454 |
| 5 | 20 | 37.8 | 47.7 | 445 |

It will be seen from a consideration of the Examples that orienting the crystalline preforms by stretching substantially increased the level of crystallinity, even for the highly crystalline specimens of Examples 4 and 5. The modulus properties of the films fabricated according to the invention are also quite high. Surprisingly, even at high levels of thermally induced crystallinity, the stretched films were transparent.

For further comparison, the biaxially stretched amorphous PET film of Example C-1 was placed in a fixed frame and heat set at 135° C. for 10 sec (Example C-1A). The crystallinity and modulus properties of the control examples are summarized in the following Table 2.

TABLE 2

| Ex. | Crystallinity | Modulus |
|---|---|---|
| No. | % | Kpsi |
| C-1 | 27.0 | 437 |
| C-1A | 34.3 | 310 |

It will be seen that heat setting the oriented film of Example C-1 provides only a modest increase in final crystallinity, and that the crystallinity in such heat set film does not reach levels that are readily obtained by stretching thermally crystallized film according to the invented process, as seen in Examples 2-5. Moreover, heat setting the oriented film significantly reduced the modulus.

Specimens of the stretched film of Example C-1, the heat set stretched film of Example C-1A, and of the stretched film of Example 2, were evaluated for CO₂ barrier properties as described above. The permeability data are summarized in the following Table 3.

Shrinkage at 100° C. for the three film specimens was also determined, using a Dynamic Mechanical Analyzer (DMA). Change in dimension for the specimens, expressed as % shrinkage, is also summarized below in Table 3.

TABLE 3

| | | CO₂ | DMA |
|---|---|---|---|
| Ex. | Crystallinity | mil cc/100 in² | Shrinkage |
| No. | % | day atm | % |
| C-1 | 27.01 | 43 | −13.6 |
| C-1A | 34.32 | 35.1 | −3.2 |
| 3 | 50.59 | 25 | 0 |

It will be apparent that thermally inducing crystallization in PET film before biaxially orienting, as in Example 3, substantially improves barrier properties and thermal dimensional stability, compared with film that is stretched in the amorphous state (Example C-1) and then heat set according to the prior art (Example C-1A).

### Examples 6-9

Additional 2 inch by 2 inch specimens were cut from the film materials that were prepared and crystallized by heating at 160° C., as described above. The specimens were subjected to unequal biaxial stretching to 2.5×4 extension at 204° C. using the Long extensional test apparatus.

### Example C-3

Amorphous PET film was subjected to unequal biaxial stretching at 102° C. to provide oriented specimens for comparison purposes.

The crystallinity and modulus properties for the Examples and the comparison Example are summarized in the following Table 4.

TABLE 4

| | Film | Total | Modulus | |
|---|---|---|---|---|
| Ex. | of Ex. | Crystallinity | Axial | Hoop |
| No. | No. | Kpsi | Kpsi | |
| C-3 | — | n.d. | 310 | 535 |
| 6 | 2 | 48.9 | 432 | 504 |
| 7 | 3 | 50.6 | 421 | 584 |
| 8 | 4 | 48.9 | 385 | 531 |
| 9 | 5 | 49.7 | 426 | 516 |

It will be seen that stretch-orienting film having high levels of thermally induced crystallinity, at least 10% and preferably greater than about 25%, at temperatures above the temperature used to thermally induce crystallization, provides film having substantially greater than 30% crystallinity, together with significantly improved gas barrier properties and improved dimensional stability at elevated temperatures.

### Bottle Molding

PET resin articles may also be biaxially stretched by blow molding. In the following examples, conventional stretch blow molding equipment, as represented by a Sidel SBO series 2 molding machine having an output of 1400 bottles per hour, was used to heat and blow mold bottles from injection molded preforms according to methods commonly employed in the container arts. Preforms were blown into cold molds. Typical mold temperatures were 65-80 F. Limited experiments were conducted whereby the performs were blown into hot molds where temperatures ranged between 180-280 C. Unless otherwise noted, blowing into a cold mold was used in the examples shown below.

### Examples 10 and 11 and C-4 and C-5

Preforms weighing about 23 g were injection molded from a modified polyethylene terephthalate containing 10% ethylene isophthalate units, obtained from KoSa (PETI-10). The Tg of amorphous PETI-10 has been disclosed in the art to be in the range of 66-70° C. The 20 oz. bottle preforms were molded to provide a low level of crystallinity, generally no greater than about 2%. The preforms were then heated by being passed through the oven of a conventional blow molding machine to develop crystallinity. The IR lamps of the oven were adjusted to provide different levels of heating over the residence time of about 75 sec. When the preforms were removed for crystallinity determination, the temperature of the preform was determined using an IR pyrometer before being quench-cooled in ice.

The preform temperatures and crystallinities are summarized below in Table 5.

TABLE 5

| Ex. | Temp. | Crystallinity |
|---|---|---|
| No. | ° C. | % |
| C-4 | 100 | 2 |
| C-5 | 112 | 3.5 |
| 10 | 120 | 11.8 |
| 11 | 135 | 18.5 |

Additional injection molded PETI-10 preforms were placed in the blow molding machine, heated to temperatures between 134 and 138° C., then biaxially stretched by blow molding. The crystallinity of the bottles was determined on the basis of density, as described above. Generally, as was found for the film and sheet materials, total crystallinity in the oriented (blow molded) bottles depended upon the degree of crystallinity in the preform. However, and quite surprisingly, total crystallinity of the bottle was increased when molded from preforms having less than about 25% crystallinity, while for preforms with crystallinity greater than about 25%, blow molding produced bottles having lower total crystallinity. Thus, blow molding a preform having 24% crystallinity provided a bottle having about 34% total crystallinity, while a preform having a crystallinity of 39% gave a bottle having a crystallinity of 16% on blow molding, and a preform having a crystallinity of about 9% gave a bottle having a total crystallinity of about 29% on blow molding.

### Examples 12-14 and C-6-C-9

Additional injection molded preforms were placed in the blow molding machine, heated to temperatures between 134 and 138° C., then biaxially stretched by blow molding to provide 16 oz and 20 oz bottles. Amorphous performs, as in Example C-4, were also blow molded at a temperature of 92° C. and under equivalent conditions to provide bottles for comparison purposes (Examples C-6-C-9).

The bottles were tested for thermal dimensional stability. Strips cut from the bottle wall were measured in the axial and radial directions, then placed in a convection oven at 100° C. for 10 min., cooled and remeasured. Shrinkage results for strips from the test and control bottles, together with crystallinity data, are summarized in the following Table 6.

Sections were cut from the sidewalls of the 16 oz. and 20 oz. PETI-10 bottles and tested for CO₂ barrier properties. The permeability tests were carried out as before using the Mocon instrument described above. The permeability data are also summarized in the following Table 6.

TABLE 6

| | | Crystallinity | | Shrinkage | | Permeability |
|---|---|---|---|---|---|---|
| Ex. | Bottle | Preform | Bottle | Axial | Radial | cc mil/100 in² |
| No. | Preform | % | % | % | % | day atm |
| C-6 | 16 oz | 2 | 18.5 | −14.5 | −11 | 35.2 |
| | amorphous | | | | | |
| 12 | 16 oz | n.d. | 19.3 | −4.3 | −5.6 | 36.2 |
| | crystalline | | | | | |
| C-7 | 20 oz | 2 | 18.8 | −14.3 | −12.4 | n.d. |
| | amorphous | | | | | |
| 13 | 20 oz | n.d. | 23.8 | −5.6 | −6.7 | 30.8 |
| | crystalline | | | | | |
| 14 | 20 oz | 30 | 26.7 | −4 | −3.1 | 27.6 |
| | crystalline | | | | | |

It will thus be apparent that bottles blown from crystalline preforms according to the invention exhibit significantly improved dimensional stability, as reflected in reduced shrinkage. This becomes particularly apparent from a comparison of the shrinkage characteristics of the bottles of Example 12 and Example C-6, both having substantially the same total crystallinity.

It will also be seen that bottles fabricated according to the invention have a high level of oriented thermally induced crystallinity and exhibit acceptable CO₂ permeability. A typical commercially-produced blown PET bottle sidewall has a permeability of 42.6 cc mil/100 in² atm day. Although the highly oriented bottle of Example C-6 also has low gas permeability, the dimensional stability is poor.

Further tests of thermal dimensional stability were carried out by filling the bottles with hot water at 185° F. (85° C.), holding for 1 min., capping the filled bottles and holding at 185° F. (85° C.) for 1 min., then placing the capped bottles in a cold water bath and cooling to room temperature. The volume and particular wall dimensions of the bottles were then determined and compared with the initial volume and dimensions. Change in volume is taken as a measure of contraction of the bottle on heating.

Additional 20 oz. bottles were blow molded at 92° C. from amorphous preforms comprising modified PET containing 2% ethylene isophthalate units (PETI-2). The Tg of amorphous PETI-2 has been disclosed in the art to be in the range 76-78° C. One set of bottles was heat set after molding, again using conventional methods. These bottles were also tested to provide further comparisons (Examples C-8 and C-9).

The bottle compositions, preform characteristics, and volume and dimensional changes are summarized in the following Table 7.

TABLE 7

| | | | Dimensional change | | | |
|---|---|---|---|---|---|---|
| Ex. | Resin | | volume | Shoulder | sidewall | Heel |
| No. | type | preform | % | % | % | % |
| 13 | PETI-10 | crystalline | −5.8 | −3.9 | −2.4 | −1.1 |
| 14 | PETI-10 | crystalline | −4.0 | −2.5 | −1.1 | −1.5 |
| C-7 | PETI-10 | amorphous | −26.4 | −10.5 | −11.0 | −3.3 |
| C-8 | PETI-2 | amorphous | −8.8 | −3.5 | −3.5 | −3.5 |
| C-9 | PETI-2 | amorphous, | −6.5 | −2.3 | −2.3 | −2.8 |
| | | (heat set) | | | | |

The bottles blown from crystalline preforms (Examples 13 and 14) according to the invention are seen to be significantly more dimensionally stable under hot fill conditions than bottles blown from amorphous preforms (Examples C-7 and C-8), even when heat set according to commercial practice (Example C-9).

### Examples 15-19, and Comparison Examples C-10-C-14

Jar (20 oz.) preforms were injection molded as described from two PET resins—PET and PETN-5, a modified PET containing 5% ethylene naphthalate units. The Tg of amorphous PETN-5 has been disclosed in the art to be 80-81° C.

The preforms were loaded into the Sidel SB-02 blow molding machine, partially crystallized by heating at various temperatures in the oven of the molding machine using a residence time of 75 sec., and then blow molded at the crystallization temperature. The heat set examples, Comparison Examples C-11 and C-14, were molded according to standard commercial practice using molds heated at 136-140° C. The crystallinities of the preforms for control examples C-10-C-14 are about 2±1%, and the preforms of Examples 15-18 are crystallized at the time of blowing to a level in the range of from about 4 to about 12%. The preform crystallization and molding temperatures employed are summarized in the following Table 8.

Film shrinkage tests conducted at 100° C. using a DMA instrument were run with 0.25 in. by 2 in. test specimens die cut from the jar side walls, as described above. The shrinkage in the axial direction for the specimens is summarized in the following Table 8. Additional test specimens were cut from sidewalls for determination of film mechanical properties. The room temperature tensile modulus of the specimens is also summarized in the following Table 8.

TABLE 8

| | | |
|---|---|---|
| Preform | Axial | Tensile Modulus |

| | | | | |
|---|---|---|---|---|
| Ex. | Temp. | Shrinkage | Axial | Radial |
| No. | ° C. | % | Kpsi | Kpsi |

PET preforms

| | | | | |
|---|---|---|---|---|
| C-10 | 105 | 7.0 | n.d. | n.d. |
| C-11 | 111 | n.d. | 380 | 364 |
| | heat set | | | |
| C-12 | 116 | 4.4 | n.d. | n.d. |
| 15 | 126 | 2.4 | 408 | 368 |
| 16 | 136 | 1.8 | 418 | 396 |

PETN-5 preforms

| | | | | |
|---|---|---|---|---|
| C-13 | 112 | 5.9 | n.d. | n.d. |
| C-14 | 111 | n.d. | 406 | 378 |
| | heat set | | | |
| 17 | 123 | 2.5 | 422 | 394 |
| 18 | 130 | 2.4 | 412 | 381 |
| 19 | 140 | 1.0 | 406 | 411 |

It will be apparent that blow molding preforms having greater than about 4% thermally induced crystallinity, (Examples 15-19) will provide jars having markedly reduced shrinkage, together with high tensile modulus properties.

Hot fill tests of thermal dimensional stability were carried out by filling the jars with hot water at 185° F. (85° C.), holding for 1 min., capping the filled jars and holding at 185° F. (85° C.) for 1 min., and then placing the capped jars in a cold water bath and cooling to room temperature. The wall dimensions of the jars were then determined and compared with the initial dimensions. Dimensional change in the shoulder and sidewall areas, expressed in %, is summarized in the following Table 9.

TABLE 9

| | | |
|---|---|---|
| | | Dimensional |
| Preform | Bottle | Change |

| | | | | |
|---|---|---|---|---|
| Ex. | Temp | Crystallinity | Shoulder | Sidewall |
| No. | ° C. | % | % | % |

PET preforms

| | | | | |
|---|---|---|---|---|
| C-10 | 105 | 24.5 | −5.8 | −3.6 |
| C-11 | 111 | 30.7 | −1.4 | −0.3 |
| | heat set | | | |
| C-12 | 116 | 26.5 | −3.3 | −2.3 |
| 15 | 126 | 29.0 | −0.9 | −1.1 |
| 16 | 136 | 30.2 | −0.7 | −1.3 |

PETN-5 preforms

| | | | | |
|---|---|---|---|---|
| C-13 | 112 | 23.5 | −3.9 | −1.6 |
| C-14 | 111 | 29.5 | −1.5 | −0.3 |
| | heat set | | | |
| 17 | 123 | 26.5 | −2.3 | −1.2 |
| 18 | 131 | 28.3 | −0.7 | −0.6 |
| 19 | 140 | 27.2 | −0.3 | −0.2 |

It will be seen that blow molding thermally crystallized preforms at elevated temperatures provides jars that are significantly improved in dimensional stability compared with jars produced by blow molding substantially amorphous preforms at the lower temperatures commonly employed in the art; compare Examples 15-19 with C-10, C-12 and C-13. Though heat set jars, (Examples C-11 and C-13) have a slightly higher level of crystallinity then jars produced according to the invented process, the dimensional stability of the heat set jars is not correspondingly better. While the shrinkage values were much more scattered, the dimensional changes observed at 90° C. were found to follow similar trends.

It will be apparent that orienting polyester resin preforms having a low level of thermally-induced crystallinity, as little as from 4 to 12%, by stretch blow molding at an elevated temperature provides biaxially oriented crystalline articles having greater than about 15%, preferably greater than 20%, crystallinity, with significantly improved thermal dimensional stability. Conversely, blow molding amorphous polyester resin preforms will be seen to provide articles that have poor thermal dimensional stability unless subjected to a further heat setting treatment, even though the total crystallinity of the articles may be nearly equivalent to the total crystallinity of bottles made by the invented process.

### Examples 20 and 21

Juice bottle (20 oz.) preforms weighing 38 g were injection molded as described above from PET and PETN-5. The preforms were loaded into the Sidel SB-02 blow molding machine, partially crystallized by heating in the oven of the molding machine using a residence time of 75 sec., and then blow molded at the crystallization temperature, using a cold mold. The PET preforms were heated to 127° C., and the PETN-5 preforms were heated to 133° C.

The bottles were subjected to the hot fill test at 85° C. as described. The PET juice bottles had a volume shrinkage of −1.0% and a reduction in height of −1.0%. The PETN-5 juice bottles had a volume shrinkage of −1.7% and a reduction in height of −0.5%. These heavy wall bottles thus perform within the industry accepted standard of less than 2% change.

In a bottle blowing operation wherein a molded preform is crystallized by heating to a particular temperature and then blow molded substantially at the crystallizing temperature in a continuous operation, the level of crystallinity that will be developed in the preform for a particular resin will be determined in part by a number of parameters: the preform geometry; the heating rate; and the dwell time. Additionally, it will be recognized that the amount of orienting that takes place during the blow molding step will vary with the geometry of the article. It will be understood by those skilled in the molding arts, that reproducibility of the crystallinity in the bottles will be affected by the ability to control these parameters, and methods for determining optimal molding conditions suited to the process equipment employed.

The methods and process steps of the invention are described and illustrated in terms of polyester resins; however, those skilled in the art will recognize that the methods may be found suitable for fabricating a wider range of crystallizable thermoplastics. These and still further additions and modifications will be readily apparent to those skilled in the art, and such modifications and additions, as well as compositions, formulations and articles embodying them, are contemplated to lie within the scope of the invention, which is defined and set forth in the following claims.

1. A method for fabricating an unoriented crystallizable thermoplastic having from about 4 to about 40% thermally induced crystallinity, said method comprising stretch orienting a preform comprising said thermoplastic at a temperature ≧(Tg+45° C.) wherein Tg is the amorphous glass transition temperature of said thermoplastic, thereby providing an oriented crystallized thermoplastic article having from about 20 to about 60% total crystallinity.

2. The method of claim 1 wherein said crystallizable thermoplastic is a polyester.

3. The method of claim 1 wherein said crystallizable thermoplastic is a polyethylene terephthalate resin.

4. The method of claim 1 wherein a preform comprising an unoriented polyethylene terephthalate resin having from about 10 to about 40% thermally induced crystallinity is biaxially stretch oriented at a temperature of from about 125° C. to about 205° C.

5. The method of claim 4 wherein said preform comprises an unoriented polyethylene terephthalate resin selected from polyethylene terephthalate, copolymers thereof containing up to 25 mole % ethylene isophthalate units, and copolymers thereof containing up to 25% ethylene naphthalate units.

6. The method of claim 1 wherein said preform is a molded preform comprising an unoriented polyethylene terephthalate resin having from about 4 to about 20% thermally induced crystallinity, and wherein said article is stretch blow molded at a temperature in the range of from about 125° C. to about 150° C.

7. The method of claim 1 wherein said oriented crystallized thermoplastic article is a blow molded bottle comprising a polyethylene terephthalate resin.

8. An oriented, crystallized thermoplastic article having from about 20 to about 60% total crystallinity, said article fabricated by stretch orienting a film comprising an unoriented crystallizable thermoplastic having from about 25 to about 40% thermally induced crystallinity at a temperature ≧(Tg+45° C.) wherein Tg is the amorphous glass transition temperature of said thermoplastic.

9. The method of claim 8 wherein said film is biaxially stretch oriented at a temperature of from about 125° C. to about 205° C.

10. A method for fabricating a highly oriented, thermoplastic article, said method comprising thermally crystallizing a substantially amorphous crystallizable thermoplastic perform, at a first temperature T₁ to provide a crystallized perform, and stretch orienting said crystallized preform at a second temperature T₂≧T₁.

11. The method of claim 10 wherein said preform is thermally crystallized to a level of from about 4 to about 40% crystallinity

12. The method of claim 10 wherein said T₁≧(Tg+45° C.), wherein Tg is the amorphous glass transition temperature of said thermoplastic.

13. The method of claim 10 wherein said crystallizable thermoplastic is a polyester.

14. The method of claim 10 wherein said crystallizable thermoplastic is a polyethylene terephthalate resin.

15. The method of claim 10 wherein said preform comprises a polyethylene terephthalate resin, said temperature T₁ lies in the range of from about 122° C. to about 150° C. and said crystallized preform is stretch oriented by blow molding.

16. The method of claim 10 wherein said preform is a polyethylene terephthalate resin film, said temperature T₁ lies in the range of from about 125° C. to about 205° C. and said crystallized preform is biaxially stretch oriented.

17. The method of claim 10 wherein said highly oriented thermoplastic article has a total crystallinity greater than about 15%.

18. The method according to claim 10 comprising heating a substantially amorphous polyethylene terephthalate resin preform at a first temperature T₁ in the range of from about 122° C. to about 180° C. to provide a crystallized preform having from about 4 to about 40% thermally induced crystallinity, and stretch orienting said preform at a second temperature T₂ in the range 125° C. to about 205° C., said T₂≧ said T₁.

19. The method according to claim 10 comprising heating a molded substantially amorphous polyethylene terephthalate resin preform at a first temperature T₁ in the range of from about 122° C. to about 150° C. to provide a crystallized preform having from about 4 to about 40% thermally induced crystallinity, and blow molding said preform at a second temperature T₂≧ said T₁, thereby providing a blow molded container having a total crystallinity in the range of from about 20 to about 60%.

20. A thermally crystallized and oriented polyethylene terephthalate homopolymer or copolymer resin article having a tensile modulus greater than about 400 Kpsi and less than about 5% shrinkage after 10 min. at 100° C, determined by DMA for a film specimen heated at a rate of 3° C./min.
